(19) United States
(12) Patent Application Publication
(10) Pub. No.: US 2024/0343019 A1
(43) Pub. Date: Oct. 17, 2024

(54) LAMINATE

(71) Applicant: FUJIFILM Corporation, Tokyo (JP)

(72) Inventor: Naoko NAKAZAWA, Shizuoka (JP)

(73) Assignee: FUJIFILM Corporation, Tokyo (JP)

(21) Appl. No.: 18/752,777

(22) Filed: Jun. 24, 2024

Related U.S. Application Data
(63) Continuation of application No. PCT/JP2022/047580, filed on Dec. 23, 2022.

(30) Foreign Application Priority Data
Jan. 31, 2022 (JP) 2022-012873

(51) Int. Cl. B32B 15/09; B32B 7/12; B32B 15/20; B32B 27/16; B32B 27/36

(52) U.S. Cl. CPC B32B 15/09; B32B 7/12; B32B 15/20; B32B 27/16; B32B 27/36; B32B 2250/02; B32B 2255/10; B32B 2255/26; B32B 2307/538; B32B 2307/748; B32B 2457/00

(57) ABSTRACT

An object of the present invention is to provide a laminate having excellent adhesiveness between a metal layer and a resin layer.

The laminate of an embodiment of the present invention has a metal layer, an adhesion layer, and a resin layer in this order, in which the resin layer includes a liquid crystal polymer, and there is no void between the metal layer and the adhesion layer, or in a case where there is such a void, there is no void with a major axis of more than 10 μm and the number of voids with a major axis of 10 μm or less is 100 voids/m² or less.

### CROSS-REFERENCE TO RELATED APPLICATIONS

This application is a Continuation of PCT International Application No. PCT/JP2022/047580 filed on Dec. 23, 2022, which claims priority under 35 U.S.C. § 119 (a) to Japanese Patent Application No. 2022-012873 filed on Jan. 31, 2022. The above applications are hereby expressly incorporated by reference, in their entirety, into the present application.

### BACKGROUND OF THE INVENTION

### 1. Field of the Invention

The present invention relates to a laminate.

### 2. Description of the Related Art

Higher frequency bands than ever before have been used in a 5th generation (5G) mobile communication system which is considered to be next-generation communication technology. Therefore, a film substrate for a circuit board for a 5G mobile communication system is required to have a low dielectric loss tangent and a low water absorption from the viewpoint of reducing a transmission loss in a high frequency band, and thus, development of film substrates using various materials is in progress.

For example, JP2016-107505A describes a single-sided metal-clad laminated plate in which a metal sheet is bonded to one surface of a film formed of a thermoplastic polymer capable of forming an optically anisotropic molten phase, in which an arithmetic average roughness and a ten-point average roughness of a surface of the thermoplastic liquid crystal polymer film on the side not bonded to the metal sheet are in specific ranges.

### SUMMARY OF THE INVENTION

The present inventors have further examined a laminate having a metal layer and a resin layer including a liquid crystal polymer with reference to the technology described in JP2016-107505A, and have thus found that there is room for further improvement in adhesiveness between the metal layer and the resin layer.

The present invention has been made in view of the circumstances, and an object thereof is to provide a laminate having excellent adhesiveness between a metal layer and a resin layer.

The present inventors have conducted intensive studies to accomplish the object, and as a result, they have found that the object can be accomplished by the following configurations.
[1] A laminate comprising, in this order:
a metal layer;
an adhesion layer; and
a resin layer,
in which the resin layer includes a liquid crystal polymer, and
there is no void between the metal layer and the adhesion layer, or in a case where there is such a void, there is no void with a major axis of more than 10 μm and the number of voids with a major axis of 10 μm or less is 100 voids/m² or less.
[2] The laminate according to [1],
in which the liquid crystal polymer includes two or more kinds of repeating units derived from a dicarboxylic acid.
[3] The laminate according to [1] or [2],
in which the liquid crystal polymer has at least one selected from the group consisting of a repeating unit derived from 6-hydroxy-2-naphthoic acid, a repeating unit derived from an aromatic diol, a repeating unit derived from terephthalic acid, and a repeating unit derived from 2,6-naphthalenedicarboxylic acid.
[4] The laminate according to any one of [1] to [3],
in which an average length RSm of roughness curve elements of an interface between the metal layer and the adhesion layer in a cross-section along a thickness direction is 1.2 μm or less.
[5] The laminate according to any one of [1] to [4],
in which a thickness of the adhesion layer is 0.3 to 5.0 μm.
[6] The laminate according to any one of [1] to [5],
in which the metal layer is a copper layer.
[7] The laminate according to any one of [1] to [6],
in which a peel strength of the metal layer from the laminate is 6.0 N/cm or more.

According to the present invention, it is possible to provide a laminate having excellent adhesiveness between a metal layer and a resin layer.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

In notations for a group (atomic group) in the present specification, in a case where the group is cited without specifying whether it is substituted or unsubstituted, the group includes both a group having no substituent and a group having a substituent as long as this does not impair the spirit of the present invention. For example, an “alkyl group” includes not only an alkyl group having no substituent (unsubstituted alkyl group), but also an alkyl group having a substituent (substituted alkyl group). In addition, an “organic group” in the present specification refers to a group including at least 1 carbon atom.

In the present specification, in a case where a resin layer or a film has an elongated shape, a width direction means a lateral direction and a transverse direction (TD) of the resin layer or the film, and a length direction means a longitudinal direction and a machine direction (MD) of the resin layer or the film.

In the present specification, for each component, one kind of substance corresponding to each component may be used alone, or two or more kinds thereof may be used in combination. Here, in a case where two or more kinds of substances are used for each component, the content of the component indicates a total content of two or more substances unless otherwise specified.

In the present specification, “to” is used in a meaning including numerical values denoted before and after “to” as a lower limit value and an upper limit value, respectively.

In the present specification, the dielectric loss tangent of the resin layer or the resin included in the resin layer as measured under the conditions of a temperature of 23° C. and a frequency of 28 GHz is also described as a “standard dielectric loss tangent”.

In the present specification, the “film width” means a distance between both ends of a long resin layer or film in the width direction.

### Laminate

The laminate according to an embodiment of the present invention is a laminate having a metal layer, an adhesion layer, and a resin layer in this order, in which the resin layer includes a liquid crystal polymer, and there is no void between the metal layer and the adhesion layer, or in a case where there is such a void, there is no void with a major axis of more than 10 μm and the number of voids with a major axis of 10 μm or less is 100 voids/m² or less.

Hereinafter, the configuration of the laminate according to the embodiment of the present invention will be described in detail.

The laminate has a metal layer, an adhesion layer, and a resin layer in this order.

As long as the laminate has at least a layer configuration in which the metal layer, the adhesion layer, and the resin layer are disposed in this order, the number of each layer is not limited and may be one or two or more.

The laminate may be a single-sided metal laminate in which a metal layer is disposed on one surface side of a resin layer, or may be a double-sided metal laminate in which a metal layer is disposed on both surface sides of a resin layer. As the double-sided metal laminate, a laminate having a metal layer, an adhesion layer, a resin layer, an adhesion layer, and a metal layer in this order is preferable.

The laminate of the embodiment of the present invention is a laminate satisfying a requirement that there is no void between the metal layer and the adhesion layer, or in a case where there is such a void, there is no void with a major axis of more than 10 μm and the number of voids with a major axis of 10 μm or less is 100 voids/m² or less (hereinafter also referred to as “Requirement A”).

By making the laminate satisfy Requirement A, it is possible to obtain a laminate which has further improved in a peel strength of the metal layer from the laminate, and has excellent adhesiveness between the metal layer and the resin layer including a liquid crystal polymer.

Hereinafter, the excellent adhesiveness between the metal layer and the resin layer in the laminate having the metal layer and the resin layer is also described as “the effect of the present invention is more excellent”.

The void between the metal layer and the adhesion layer in the laminate can be measured using an ultrasonic inspection device (FineSAT (registered trademark) III manufactured by Hitachi Power Solutions Co., Ltd.). It is considered that this void is a space (defect) in which none of the components constituting the metal layer and the adhesion layer are included. Specifically, the number of the voids is determined by scanning the reflection of ultrasonic waves with which the laminate was irradiated, using the ultrasonic inspection device, imaging an interface between the metal layer and the adhesion layer based on a waveform detected by the scanning, and counting the voids displayed in the obtained image.

In a case of determining the number of the voids between the metal layer and the adhesion layer, the laminate may be immersed in a liquid capable of dissolving a metal, such as sulfuric acid, as necessary, to remove the metal layer so that the voids between the resin layer and the adhesion layer are not counted, and the obtained specimen having the resin layer and the adhesion layer may be measured in the same manner as described above.

The “major axis” of the voids to be measured is a maximum value of the distance between two straight lines in a case where two parallel straight lines are assumed to be interposed between the displayed voids and be in contact with the contour lines of the voids.

In the measurement, a void with a major axis larger than a detection limit of the ultrasonic inspection device is measured. The detection limit of the ultrasonic inspection device is usually about 1 μm. In addition, the expression “there is no void (or void with a major axis of more than 10 μm) between the metal layer and the adhesion layer” means that a void (or a void with a major axis of more than 10 μm) that can be detected by the device is not observed in the image.

A detailed method for measuring the void between the metal layer and the adhesion layer will be described in the Example section which will be described later.

In a case where there is a void between the metal layer and the adhesion layer, it is preferable that the number of voids with a major axis of 10 μm or less is 90 voids/m² or less. It is more preferable that there is no void between the metal layer and the adhesion layer (that is, the void is not observed by the measurement method).

### Metal Layer

Examples of a material constituting the metal layer include metals used for electrical connection. Examples of such metals include copper, gold, silver, nickel, aluminum, and alloys including any of these metals. Examples of the alloy include a copper-zinc alloy, a copper-nickel alloy, and a zinc-nickel alloy.

As the metal layer, a copper layer is preferable from the viewpoint that the conductivity and the workability are excellent. The copper layer is a layer consisting of copper or a copper alloy including 95% by mass or more of copper. Examples of the copper layer include a rolled copper foil produced by a rolling method, and an electrolytic copper foil produced by an electrolysis method. The metal layer may be subjected to a chemical treatment such as pickling.

In a case where a metal foil such as a copper foil is used for manufacturing the laminate, the RSm of a surface of the metal foil on the side in contact with the adhesion layer is preferably 1.5 μm or less, more preferably 1.2 μm or less, and still more preferably 0.9 μm or less. The lower limit value is not particularly limited, but is preferably 0.1 μm or more, and more preferably 0.3 μm or more.

In a case where a metal foil whose surface in contact with the adhesion layer in the laminate has an RSm in the range is used, it is easy to manufacture the laminate in which the RSm of the interface is in a preferred range which will be described later.

Examples of the metal foil whose surface having the RSm in the range include a non-roughened copper foil, which is available on the market.

The RSm of the surface of the metal foil can be measured according to a method for measuring an RSm of an interface in a laminate which will be described later from a cross-section obtained by subjecting a metal foil in a resin for observation to an embedding treatment, and then cutting the embedding-treated metal foil along the thickness direction.

A thickness of the metal layer is not particularly limited, and is appropriately selected depending on the application of a circuit board. However, in terms of wiring line conductivity and economy, the thickness is preferably 4 to 100 μm, and more preferably 10 to 35 μm.

### Adhesion Layer

The laminate has at least one adhesion layer disposed between the metal layer and the resin layer.

As the adhesion layer, a known adhesive layer used for manufacturing a wiring board such as a copper-clad laminate can be used, and examples thereof include a layer consisting of a cured product of an adhesive composition including a known binder resin.

### <Composition of Adhesion Layer>

### (Binder Resin)

The adhesion layer preferably includes a binder resin.

Examples of the binder resin include a (meth)acrylic resin, a polyvinyl cinnamate, a polycarbonate, a polyimide, a polyamideimide, a polyesterimide, a polyetherimide, a polyether ketone, a polyether ether ketone, a polyethersulfone, a polysulfone, a polyparaxylene, a polyester, a polyvinyl acetal, a polyvinyl chloride, a polyvinyl acetate, a polyamide, a polystyrene, a polyurethane, a polyvinyl alcohol, a cellulose acylate, a fluororesin, a liquid crystal polymer, a syndiotactic polystyrene, a silicone resin, an epoxy silicone resin, a phenol resin, an alkyd resin, an epoxy resin, a maleic acid resin, a melamine resin, a urea resin, an aromatic sulfonamide, a benzoguanamine resin, a silicone elastomer, an aliphatic polyolefin (for example, polyethylene and polypropylene), and a cyclic olefin copolymer. Among these, the polyimide, the liquid crystal polymer, the polyimide, the syndiotactic polystyrene, or the cyclic olefin copolymer is preferable, and the polyimide is more preferable.

The binder resins may be used alone or in combination of two or more kinds thereof.

A content of the binder resin is preferably 60% to 99.9% by mass, more preferably 70% to 99.0% by mass, and still more preferably 80% to 97.0% by mass with respect to the total mass of the adhesion layer.

### (Reactive Compound)

The adhesion layer may include a reaction product of a compound having a reactive group. Hereinafter, the compound having a reactive group and a reaction product thereof are also collectively referred to as a “reactive compound”.

The adhesion layer preferably includes a reactive compound.

The reactive group contained in the reactive compound is preferably a group capable of reacting with a group that may exist on a surface of the resin layer (in particular, a group having an oxygen atom, such as a carboxy group and a hydroxy group).

Examples of the reactive group include an epoxy group, an oxetanyl group, an isocyanate group, an acid anhydride group, a carbodiimide group, an N-hydroxyester group, a glyoxal group, an imide ester group, an alkyl halide group, and a thiol group; and at least one group selected from the group consisting of the epoxy group, the acid anhydride group, and the carbodiimide group is preferable, and the epoxy group is more preferable.

Specific examples of the reactive compound having an epoxy group include aromatic glycidylamine compounds (for example, N,N-diglycidyl-4-glycidyloxyaniline, 4,4′-methylenebis (N,N-diglycidylaniline), N,N-diglycidyl-o-toluidine, and N,N,N′,N′-tetraglycidyl-m-xylene diamine, 4-t-butylphenylglycidyl ether), aliphatic glycidylamine compounds (for example, 1,3-bis(diglycidylaminomethyl)cyclohexane), and aliphatic glycidyl ether compounds (for example, sorbitol polyglycidyl ether). Among these, the aromatic glycidylamine compounds are preferable.

Specific examples of the reactive compound having an acid anhydride group include tetracarboxylic dianhydrides (for example, 3,3′,4,4′-benzophenone tetracarboxylic dianhydride, 3,3′,4,4′-biphenyltetracarboxylic dianhydride, pyromellitic dianhydride, 2,3,3′,4′-biphenyltetracarboxylic dianhydride, oxydiphthalic dianhydride, diphenylsulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, bis(3,4-dicarboxyphenyl)methane dianhydride, 2,2-bis(3,4-dicarboxyphenyl)propane dianhydride, p-phenylenebis(trimellitic acid monoester anhydride), p-biphenylenebis(trimellitic acid monoester anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride, 2,3,6,7-naphthalenetetracarboxylic dianhydride, 1,4,5,8-naphthalenetetracarboxylic dianhydride, and 4,4′-(2,2-hexafluoroisopropyridene)diphthalic dianhydride).

Specific examples of the reactive compound having a carbodiimide group include monocarbodiimide compounds (for example, dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, di-β-naphthylcarbodiimide, N,N′-di-2,6-diisopropylphenylcarbodiimide), and polycarbodiimide compounds (for example, the compounds described in U.S. Pat. No. 2,941,956A, JP1972-033279B (JP-S47-033279B), J. Org. Chem. 28, p. 2069-2075 (1963), Chemical Review 1981, 81, No. 4, p. 619-621, and the like).

Examples of a commercially available product of the reactive compound having a carbodiimide group include Carbodilite (registered trademark) HMV-8CA, LA-1, and V-03 (both manufactured by Nisshinbo Chemical Inc.), and Stabaxol (registered trademark) P, P100, and P400 (all manufactured by Rhein Chemie Japan Ltd.), and Stabilizer 9000 (trade name, manufactured by Rhein Chemie Corporation).

The number of the reactive groups contained in the reactive compound is 1 or more, but is preferably 3 or more from the viewpoint that the adhesiveness of the metal layer is more excellent.

The number of the reactive groups contained in the reactive compound is preferably 6 or less, more preferably 5 or less, and still more preferably 4 or less.

A reaction product of the compound having a reactive group is not particularly limited as long as it is a compound derived from the compound having a reactive group, and examples thereof include a reaction product obtained by a reaction between the reactive group of the compound having a reactive group and a group including an oxygen atom present on a surface of the polymer film.

The reactive compounds may be used alone or in combination of two or more kinds thereof.

The content of the reactive compound is preferably 0.1% to 40% by mass, and more preferably 1% to 30% by mass with respect to the total mass of the adhesion layer.

The adhesion layer may include a component (hereinafter also referred to as an “additive”) other than the reactive compound and the binder resin.

Examples of the additive include an inorganic filler, a curing catalyst, and a flame retardant.

A content of the additive is preferably 0.1% to 40% by mass, more preferably 1% to 30% by mass, and still more preferably 3% to 20% by mass with respect to the total mass of the adhesion layer.

The adhesion layer may include, as a residual solvent, an organic solvent included in the composition for forming an adhesion layer which will be described later as a solvent.

### <Physical Properties of Adhesion Layer>

### (Thickness)

From the viewpoint that the effect of the present invention is more excellent, the thickness of the adhesion layer is preferably 0.1 to 8.0 μm, more preferably 0.3 to 5.0 μm, and still more preferably 0.5 to 3.0 μm.

In addition, from the viewpoint that the effect of the present invention is more excellent, a ratio of the thickness of the adhesion layer to the thickness of the resin layer is preferably 0.1% to 20%, and more preferably 0.5% to 10%.

Furthermore, the thickness of the adhesion layer is a thickness per adhesion layer.

The thickness of the adhesion layer can be measured according to a method for measuring a thickness of a resin layer which will be described later.

### Resin Layer

### <Liquid Crystal Polymer>

The resin layer is a layer including a liquid crystal polymer.

The liquid crystal polymer included in the resin layer is not particularly limited, and examples thereof include a melt-moldable liquid crystal polymer.

As the liquid crystal polymer, a thermotropic liquid crystal polymer is preferable. The thermotropic liquid crystal polymer means a polymer which exhibits liquid crystallinity in a molten state in case of heating it in a predetermined temperature range.

The thermotropic liquid crystal polymer is not particularly limited as long as it is a melt-moldable liquid crystal polymer, and examples thereof include a thermoplastic liquid crystal polyester and a thermoplastic polyester amide with an amide bond introduced into the thermoplastic liquid crystal polyester.

As the liquid crystal polymer, for example, the thermoplastic liquid crystal polymer described in WO2015/064437A and JP2019-116586A can be used.

More specific examples of the liquid crystal polymer include a thermoplastic liquid crystal polyester or thermoplastic liquid crystal polyester amide having a repeating unit derived from at least one selected from the group consisting of an aromatic hydroxycarboxylic acid, an aromatic or aliphatic diol, an aromatic or aliphatic dicarboxylic acid, an aromatic diamine, an aromatic hydroxyamine, and an aromatic aminocarboxylic acid.

Examples of the aromatic hydroxycarboxylic acid include parahydroxybenzoic acid, metahydroxybenzoic acid, 6-hydroxy-2-naphthoic acid, and 4-(4-hydroxyphenyl)benzoic acid. These compounds may have substituents such as a halogen atom, a lower alkyl group, and a phenyl group. Among these, the parahydroxybenzoic acid or the 6-hydroxy-2-naphthoic acid is preferable.

As the aromatic or aliphatic diol, the aromatic diol is preferable. Examples of the aromatic diol include hydroquinone, 4,4′-dihydroxybiphenyl, 3,3′-dimethyl-1,1′-biphenyl-4,4′-diol, and acylated products thereof, and hydroquinone or 4,4′-dihydroxybiphenyl is preferable.

As the aromatic or aliphatic dicarboxylic acid, the aromatic dicarboxylic acid is preferable. Examples of the aromatic dicarboxylic acid include terephthalic acid, isophthalic acid, and 2,6-naphthalenedicarboxylic acid, and terephthalic acid is preferable.

Examples of the aromatic diamine, the aromatic hydroxyamine, and the aromatic aminocarboxylic acid include p-phenylenediamine, 4-aminophenol, and 4-aminobenzoic acid.

The liquid crystal polymer preferably includes a repeating unit derived from a dicarboxylic acid (an aromatic or aliphatic dicarboxylic acid) among the repeating units, and from the viewpoint that the low dielectric constant is more excellent, the liquid crystal polymer more preferably includes two or more kinds of the repeating units. As the dicarboxylic acid in this case, the aromatic dicarboxylic acid is preferable, and terephthalic acid, isophthalic acid, or 2,6-naphthalenedicarboxylic acid is more preferable.

In addition, it is preferable that the liquid crystal polymer has at least one selected from the group consisting of the repeating units represented by Formulae (1) to (3).

—O—Ar1—CO— (1)

—CO—Ar2—CO— (2)

—X—Ar3—Y— (3)

In Formula (1), Ar1 represents a phenylene group, a naphthylene group, or a biphenylylene group.

In Formula (2), Ar2 represents a phenylene group, a naphthylene group, a biphenylylene group, or a group represented by Formula (4).

In Formula (3), Ar3 represents a phenylene group, a naphthylene group, a biphenylylene group, or the group represented by Formula (4), and X and Y each independently represent an oxygen atom or an imino group.

—Ar4—Z—Ar5— (4)

In Formula (4), Ar4 and Ar5 each independently represent a phenylene group or a naphthylene group, and Z represents an oxygen atom, a sulfur atom, a carbonyl group, a sulfonyl group, or an alkylene group.

The phenylene group, the naphthylene group, and the biphenylylene group may have a substituent selected from the group consisting of a halogen atom, an alkyl group, and an aryl group.

Among those, the liquid crystal polymer preferably has at least one selected from the group consisting of the repeating unit derived from an aromatic hydroxycarboxylic acid represented by Formula (1), the repeating unit derived from an aromatic diol derived from Formula (3), in which both X and Y are oxygen atoms, and the repeating unit derived from an aromatic dicarboxylic acid represented by Formula (2).

In addition, the liquid crystal polymer more preferably has at least a repeating unit derived from an aromatic hydroxycarboxylic acid, still more preferably has at least one selected from the group consisting of the repeating unit derived from parahydroxybenzoic acid and the repeating unit derived from 6-hydroxy-2-naphthoic acid, and particularly preferably has the repeating unit derived from parahydroxybenzoic acid and the repeating unit derived from 6-hydroxy-2-naphthoic acid.

In addition, as another preferred aspect, from the viewpoint that the transmission loss in a high frequency band is more excellent, the liquid crystal polymer preferably has at least one selected from the group consisting of the repeating unit derived from 6-hydroxy-2-naphthoic acid, the repeating unit derived from an aromatic diol, the repeating unit derived from terephthalic acid, and the repeating unit derived from a 2,6-naphthalenedicarboxylic acid, and more preferably has all of the repeating unit derived from 6-hydroxy-2-naphthoic acid, the repeating unit derived from an aromatic diol, the repeating unit derived from terephthalic acid, and the repeating unit derived from 2,6-naphthalenedicarboxylic acid.

In a case where the liquid crystal polymer includes the repeating unit derived from an aromatic hydroxycarboxylic acid, a compositional ratio thereof is preferably 50% to 65% by mole with respect to all the repeating units of the liquid crystal polymer. In addition, it is also preferable that the liquid crystal polymer has only the repeating unit derived from an aromatic hydroxycarboxylic acid.

In a case where the liquid crystal polymer includes the repeating unit derived from an aromatic diol, a compositional ratio thereof is preferably 17.5% to 25% by mole with respect to all the repeating units of the liquid crystal polymer.

In a case where the liquid crystal polymer includes the repeating unit derived from an aromatic dicarboxylic acid, a compositional ratio thereof is preferably 11% to 23% by mole with respect to all the repeating units of the liquid crystal polymer.

In a case where the liquid crystal polymer includes the repeating unit derived from any of an aromatic diamine, an aromatic hydroxyamine, and an aromatic aminocarboxylic acid, a compositional ratio thereof is preferably 2% to 8% by mole with respect to all the repeating units of the liquid crystal polymer.

A method for synthesizing the liquid crystal polymer is not particularly limited, and the compound can be synthesized by polymerizing the compound by a known method such as melt polymerization, solid phase polymerization, solution polymerization, and slurry polymerization.

As the liquid crystal polymer, a commercially available product may be used. Examples of the commercially available product of the liquid crystal polymer include “LAPEROS” manufactured by Polyplastics Co., Ltd., “Vectra” manufactured by Celanese Corporation, “UENO LCP” manufactured by Ueno Fine Chemicals Industry, Ltd., “SUMIKA SUPER LCP” manufactured by Sumitomo Chemical Company, “Xydar” manufactured by ENEOS LC Co., Ltd., and “Siveras” manufactured by Toray Industries, Inc.

Furthermore, the liquid crystal polymer may form a chemical bond in the resin layer with a crosslinking agent, a compatible component (reactive compatibilizer), or the like which is an optional component. The same applies to components other than the liquid crystal polymer.

From the viewpoint that the transmission loss in a high frequency band is more excellent, a standard dielectric loss tangent of the liquid crystal polymer is preferably less than 0.002, more preferably 0.0015 or less, and still more preferably 0.001 or less. The lower limit value is not particularly limited, and may be, for example, 0.0001 or more.

Furthermore, in a case where the resin layer includes two or more kinds of liquid crystal polymers, the “dielectric loss tangent of the liquid crystal polymer” means a mass-average value of the dielectric loss tangents of two or more kinds of liquid crystal polymers.

The standard dielectric loss tangent of the liquid crystal polymer included in the resin layer can be measured by the following method.

First, after performing immersion in an organic solvent (for example, pentafluorophenol) in an amount of 1,000 times by mass with respect to the total mass of the resin layer, the mixture is heated at 120° C. for 12 hours to elute the organic solvent-soluble components including the liquid crystal polymer into the organic solvent. Next, the eluate including the liquid crystal polymer and the non-eluted components are separated by filtration. Subsequently, acetone is added to the eluate as a poor solvent to precipitate a liquid crystal polymer, and the precipitate is separated by filtration.

A standard dielectric loss tangent of the liquid crystal polymer can be obtained by filling the obtained precipitate in a polytetrafluoroethylene (PTFE) tube (outer diameter: 2.5 mm, inner diameter: 1.5 mm, length 10 mm), measuring the dielectric characteristics by a cavity resonator perturbation method under the conditions of a temperature of 23° C. and a frequency of 28 GHz, using with a cavity resonator (for example, “CP-531” manufactured by Kanto Electronics Application & Development, Inc.), and correcting the influence of voids in the PTFE tube by a Bruggeman equation and a void ratio.

The void ratio (volume fraction of the void in the tube) is calculated as follows. The volume of a space inside the tube is determined from the inner diameter and the length of the tube. Next, the weights of the tube before and after filling the precipitate are measured to determine the mass of the filled precipitate, and then the volume of the filled precipitate is determined from the obtained mass and the specific gravity of the precipitate. The void ratio can be calculated by dividing the volume of the precipitate thus obtained by the volume of the space in the tube determined above.

Furthermore, in a case where a commercially available product of the liquid crystal polymer is used, a numerical value of the dielectric loss tangent described as a catalog value of the commercially available product may be used.

As for the liquid crystal polymer, the melting point Tm is preferably 250° C. or higher, more preferably 280° C. or higher, and still more preferably 310° C. or higher from the viewpoint that the heat resistance is more excellent.

The upper limit value of the melting point Tm of the liquid crystal polymer is not particularly limited, but is preferably 400° C. or lower, and more preferably 380° C. or lower from the viewpoint that the moldability is more excellent.

The melting point Tm of the liquid crystal polymer can be determined by measuring a temperature at which the endothermic peak appears, using a differential scanning calorimeter (“DSC-60A” manufactured by Shimadzu Corporation). In a case where a commercially available product of the liquid crystal polymer is used, the melting point Tm described as the catalog value of the commercially available product may be used.

A number-average molecular weight (Mn) of the liquid crystal polymer is not particularly limited, but is preferably 10,000 to 600,000, and more preferably 30,000 to 150,000.

The number-average molecular weight of the liquid crystal polymer is a polystyrene-equivalent value measured by GPC, and can be measured by a method similar to the method for measuring the number-average molecular weight of the resin layer.

The liquid crystal polymers may be used alone or in combination of two or more kinds thereof.

A content of the liquid crystal polymer is preferably 40% to 99.9% by mass, more preferably 50% to 95% by mass, and still more preferably 60% to 90% by mass with respect to the total mass of the resin layer.

Furthermore, the content of the liquid crystal polymer and the components described below in the resin layer can be measured by a known method such as infrared spectroscopy and gas chromatography mass spectrometry.

### <Optional Components>

The resin layer may include optional components other than the polymer. Examples of the optional components include a polyolefin, other polymers, compatible components, a heat stabilizer, a crosslinking agent, and a lubricant.

### (Polyolefin)

The resin layer may include a polyolefin.

In the present specification, the “polyolefin” is intended to be a polymer (a polyolefin resin) having a repeating unit derived from an olefin.

The resin layer preferably includes the liquid crystal polymer and the polyolefin, and more preferably includes the liquid crystal polymer, the polyolefin, and the compatible component.

By using the polyolefin together with the liquid crystal polymer, a resin layer having a dispersed phase formed of the polyolefin can be produced. A method for producing the resin layer having the dispersed phase will be described later.

The polyolefin may be linear or branched. In addition, the polyolefin may have a cyclic structure such as a polycycloolefin.

Examples of the polyolefin include polyethylene, polypropylene (PP), polymethylpentene (TPX and the like manufactured by Mitsui Chemicals, Inc.), hydrogenated polybutadiene, a cycloolefin polymer (COP, Zeonor and the like manufactured by ZEON Corporation), and a cycloolefin copolymer (COC, APEL and the like manufactured by Mitsui Chemicals, Inc.).

The polyethylene may be either high density polyethylene (HDPE) or low density polyethylene (LDPE). In addition, the polyethylene may be linear low density polyethylene (LLDPE).

The polyolefin may be a copolymer of an olefin and a copolymerization component other than the olefin, such as acrylate, methacrylate, styrene, and/or a vinyl acetate-based monomer.

Examples of the polyolefin as the copolymer include a styrene-ethylene/butylene-styrene copolymer (SEBS). SEBS may be hydrogenated.

However, from the viewpoint that the transmission loss in a high frequency band is more excellent, it is preferable that a copolymerization ratio of the copolymerization component other than the olefin is small, and it is more preferable that the copolymerization component is not included. For example, a content of the copolymerization component is preferably 0% to 40% by mass, and more preferably 0% to 5% by mass with respect to the total mass of the polyolefin.

In addition, it is preferable that the polyolefin does not substantially include a reactive group which will be described later. In a case where the polyolefin has a reactive group, a content of the repeating unit having a reactive group is preferably 0% to 3% by mass with respect to the total mass of the polyolefin.

As the polyolefin, polyethylene, COP, or COC is preferable, polyethylene is more preferable, and the low-density polyethylene (LDPE) is still more preferable.

The polyolefins may be used alone or in combination of two or more kinds thereof.

In a case where the resin layer includes a polyolefin, a content thereof is preferably 0.1% by mass or more, and more preferably 5% by mass or more with respect to the total mass of the resin layer from the viewpoint that the surface properties of the resin layer are more excellent. The upper limit is not particularly limited, but is preferably 50% by mass or less, more preferably 40% by mass or less, and still more preferably 25% by mass or less with respect to the total mass of the resin layer from the viewpoint that the smoothness of the resin layer is more excellent. In addition, in a case where the content of the polyolefin is 50% by mass or less, a thermal deformation temperature thereof can be easily raised sufficiently and the solder heat resistance can be improved.

### (Compatible Components)

Examples of the compatible component include a polymer (non-reactive compatibilizer) having a moiety having high compatibility or affinity with the liquid crystal polymer and a polymer (reactive compatibilizer) having a reactive group for a phenol-based hydroxyl group or a carboxyl group at the terminal of the liquid crystal polymer.

As the reactive group included in the reactive compatibilizer, an epoxy group or a maleic anhydride group is preferable.

As the compatible component, a copolymer having a portion having a high compatibility or a high affinity with the polyolefin is preferable. In addition, in a case where a film includes a polyolefin and a compatible component, a reactive compatibilizer is preferable as the compatible component from the viewpoint that the polyolefin can be finely dispersed.

Furthermore, the compatible component (in particular, the reactive compatibilizer) may form a chemical bond with a component such as a liquid crystal polymer in the resin layer.

Examples of the reactive compatibilizer include an epoxy group-containing polyolefin-based copolymer, an epoxy group-containing vinyl-based copolymer, a maleic anhydride-containing polyolefin-based copolymer, a maleic anhydride-containing vinyl copolymer, an oxazoline group-containing polyolefin-based copolymer, an oxazoline group-containing vinyl-based copolymer, and a carboxyl group-containing olefin-based copolymer. Among these, the epoxy group-containing polyolefin-based copolymer or the maleic anhydride-grafted polyolefin-based copolymer is preferable.

Examples of the epoxy group-containing polyolefin-based copolymer include an ethylene/glycidyl methacrylate copolymer, an ethylene/glycidyl methacrylate/vinyl acetate copolymer, an ethylene/glycidyl methacrylate/methyl acrylate copolymer, a polystyrene graft copolymer to an ethylene/glycidyl methacrylate copolymer (EGMA-g-PS), a polymethylmethacrylate graft copolymer to an ethylene/glycidyl methacrylate copolymer (EGMA-g-PMMA), and an acrylonitrile/styrene graft copolymer to an ethylene/glycidyl methacrylate copolymer (EGMA-g-AS).

Examples of a commercially available product of the epoxy group-containing polyolefin-based copolymer include Bondfast 2C and Bondfast E manufactured by Sumitomo Chemical Company; Lotadar manufactured by Arkema S. A.; and Modiper A4100 and Modiper A4400 manufactured by NOF Corporation.

Examples of the epoxy group-containing vinyl-based copolymer include a glycidyl methacrylate grafted polystyrene (PS-g-GMA), a glycidyl methacrylate grafted polymethyl methacrylate (PMMA-g-GMA), and a glycidyl methacrylate grafted polyacrylonitrile (PAN-g-GMA).

Examples of the maleic anhydride-containing polyolefin-based copolymer include a maleic anhydride grafted polypropylene (PP-g-MAH), a maleic anhydride grafted ethylene/propylene rubber (EPR-g-MAH), and a maleic anhydride grafted ethylene/propylene/diene rubber (EPDM-g-MAH).

Examples of a commercially available product of the maleic anhydride-containing polyolefin-based copolymer include Orevac G series manufactured by Arkema S.A.; and FUSABOND E series manufactured by The Dow Chemical Company.

Examples of the maleic anhydride-containing vinyl copolymer include a maleic anhydride grafted polystyrene (PS-g-MAH), a maleic anhydride grafted styrene/butadiene/styrene copolymer (SBS-g-MAH), a maleic anhydride grafted styrene/ethylene/butene/styrene copolymer (SEBS-g-MAH and a styrene/maleic anhydride copolymer, and an acrylic acid ester/maleic anhydride copolymer.

Examples of a commercially available product of the maleic anhydride-containing vinyl copolymer include TUFTEC M Series (SEBS-g-MAH) manufactured by Asahi Kasei Corporation.

In addition to those, examples of the compatible component include oxazoline-based compatibilizers (for example, a bisoxazoline-styrene-maleic anhydride copolymer, a bisoxazoline-maleic anhydride-modified polyethylene, and a bisoxazoline-maleic anhydride-modified polypropylene), elastomer-based compatibilizers (for example, an aromatic resin and a petroleum resin), and ethylene glycidyl methacrylate copolymer, an ethylene maleic anhydride ethyl acrylate copolymer, ethylene glycidyl methacrylate-acrylonitrile styrene, acid-modified polyethylene wax, a COOH-modified polyethylene graft polymer, a COOH-modified polypropylene graft polymer, a polyethylene-polyamide graft copolymer, a polypropylene-polyamide graft copolymer, a methyl methacrylate-butadiene-styrene copolymer, acrylonitrile-butadiene rubber, an EVA-PVC-graft copolymer, a vinyl acetate-ethylene copolymer, an ethylene-α-olefin copolymer, a propylene-α-olefin copolymer, a hydrogenated styrene-isopropylene-block copolymer, and an amine-modified styrene-ethylene-butene-styrene copolymer.

In addition, as the compatible component, an ionomer resin may be used.

Examples of such an ionomer resin include an ethylene-methacrylic acid copolymer ionomer, an ethylene-acrylic acid copolymer ionomer, a propylene-methacrylic acid copolymer ionomer, a butylene-acrylic acid copolymer ionomer, a propylene-acrylic acid copolymer ionomer, an ethylene-vinyl sulfonic acid copolymer ionomer, a styrene-methacrylic acid copolymer ionomer, a sulfonated polystyrene ionomer, a fluorine-based ionomer, a telechelic polybutadiene acrylic acid ionomer, a sulfated ethylene-propylene-diene copolymer ionomer, hydrogenated polypentamer ionomer, a polypentamer ionomer, a poly(vinyl pyridium salt) ionomer, a poly(vinyltrimethylammonium salt) ionomer, a poly(vinyl benzyl phosphonium salt) ionomer, a styrene-butadiene acrylic acid copolymer ionomer, a polyurethane ionomer, a sulfated styrene-2-acrylamide-2-methyl propane sulfate ionomer, am acid-amine Ionomer, an aliphatic ionene, and an aromatic ionene.

In a case where the resin layer includes the compatible component, a content thereof is preferably 0.05% to 30% by mass, more preferably 0.1% to 20% by mass, and still more preferably 0.5% to 10% by mass with respect to the total mass of the resin layer.

### (Heat Stabilizer)

The resin layer may include a heat stabilizer for the purpose of suppressing thermal oxidative deterioration during film formation through melt extrusion, and improving the flatness and the smoothness of a surface of the resin layer.

Examples of the heat stabilizer include a phenol-based stabilizer and an amine-based stabilizer, each having a radical scavenging action; a phosphite-based stabilizer and a sulfur-based stabilizer, each having a decomposition action of a peroxide; and a hybrid stabilizer having a radical scavenging action and a decomposition action of a peroxide.

Examples of the phenol-based stabilizer include a hindered phenol-based stabilizer, a semi-hindered phenol-based stabilizer, and a less hindered phenol-based stabilizer.

Examples of a commercially available product of the hindered phenol-based stabilizer include ADK STAB AO-20, AO-50, AO-60, and AO-330 manufactured by ADEKA Corporation; and Irganox 259, 1035, and 1098 manufactured by BASF.

Examples of a commercially available product of the semi-hindered phenol-based stabilizer include ADK STAB AO-80 manufactured by ADEKA Corporation; and Irganox 245 manufactured by BASF.

Examples of a commercially available product of the less hindered phenol-based stabilizer include NOCRAC 300 manufactured by Ouchi Shinko Chemical Industrial Co., Ltd.; and ADK STAB AO-30 and AO-40 manufactured by ADEKA Corporation.

Examples of a commercially available product of the phosphite-based stabilizer include ADK STAB-2112, PEP-8, PEP-36, and HP-10 manufactured by ADEKA Corporation.

Examples of a commercially available product of the hybrid stabilizer include SUMILIZER GP manufactured by Sumitomo Chemical Company.

As the heat stabilizer, the hindered phenol-based stabilizer, the semi-hindered phenol-based stabilizer, or the phosphite-based stabilizer is preferable, and the hindered phenol-based stabilizer is more preferable from the viewpoint that the heat stabilization effect is more excellent. On the other hand, in terms of electrical characteristics, the semi-hindered phenol-based stabilizer or the phosphite-based stabilizer is more preferable.

The heat stabilizers may be used alone or in combination of two or more kinds thereof.

In a case where the resin layer includes the heat stabilizer, a content of the heat stabilizer is preferably 0.0001% to 10% by mass, more preferably 0.01% to 5% by mass, and still more preferably 0.1% to 2% by mass with respect to the total mass of the resin layer.

### (Additive)

The resin layer may include an additive other than the components. Examples of the additive include a plasticizer, a lubricant, inorganic and organic particles, and a UV absorbing material.

Examples of the plasticizer include an alkylphthalyl alkyl glycolate compound, a bisphenol compound (bisphenol A, bisphenol F), an alkylphthalyl alkyl glycolate compound, a phosphoric acid ester compound, a carboxylic acid ester compound, and a polyhydric alcohol. A content of the plasticizer may be 0% to 5% by mass with respect to the total mass of the resin layer.

Examples of the lubricant include a fatty acid ester and a metal soap (for example, a stearic acid inorganic salt). A content of the lubricant may be 0% to 5% by mass with respect to the total mass of the resin layer.

The resin layer may contain inorganic particles and/or organic particles as a reinforcing material, a matting agent, a dielectric constant, or a dielectric loss tangent improving material. Examples of the inorganic particles include silica, titanium oxide, barium sulfate, talc, zirconia, alumina, silicon nitride, silicon carbide, calcium carbonate, silicate, glass beads, graphite, tungsten carbide, carbon black, clay, mica, carbon fiber, glass fiber, and metal powder. Examples of the organic particles include crosslinked acryl and crosslinked styrene. The content of the inorganic particles and the organic particles may be 0% to 50% by mass with respect to the total mass of the resin layer.

Examples of the UV absorbing material include a salicylate compound, a benzophenone compound, a benzotriazole compound, a substituted acrylonitrile compound, and an s-triazine compound. The content of the UV absorbing material may be 0% to 5% by mass with respect to the total mass of the resin layer.

In addition, the resin layer may include another polymer component other than the liquid crystal polymer.

Examples of such another polymer component include polymers having a low dielectric loss tangent, such as a fluororesin, a polyimide, and a modified polyimide, and thermoplastic polymers such as polyethylene terephthalate, modified polyethylene terephthalate, polycarbonate, polyarylate, polyamide, polyphenylene sulfide, and polyester ether ketone.

### <Physical Properties of Resin Layer>

### (Thickness)

A thickness of the resin layer is preferably 5 to 1,000 μm, more preferably 10 to 500 μm, and still more preferably 20 to 300 μm.

The thickness of the resin layer is an arithmetic mean value calculated from measured values obtained by measuring the thickness of the resin layer at any 100 different points from an observed image obtained by observing a cross-section of the laminate in the thickness direction using a scanning electron microscope (SEM).

### (Dielectric Characteristics)

The standard dielectric loss tangent of the resin layer is preferably 0.002 or less, more preferably 0.0015 or less, and still more preferably 0.001 or less. The lower limit value is not particularly limited, and may be 0.0001 or more.

A relative permittivity of the resin layer varies depending on the application, but is preferably 2.0 to 4.0, and more preferably 2.5 to 3.5.

The dielectric characteristics including the dielectric loss tangent of the resin layer can be measured, for example, by sampling a center portion of the resin layer included in the laminate, and using a split cylinder type resonator (“CR-728” manufactured by Kanto Electronics Application & Development, Inc.) and a network analyzer (Keysight N5230A).

### (Dispersed Phase)

In a case where the resin layer includes a polyolefin, it is preferable that the polyolefin forms a dispersed phase in the resin layer. The dispersed phase corresponds to an island portion in a resin layer having a so-called sea-island structure inside.

A method of forming the sea-island structure in the resin layer and allowing the polyolefin to exist as a dispersed phase is not limited, and for example, a dispersed phase of a polyolefin can be formed by adjusting each of the contents of the liquid crystal polymer and the polyolefin included in the resin layer to the above-mentioned preferred contents.

An average dispersion diameter of the dispersed phase is preferably 0.001 to 50.0 μm, more preferably 0.005 to 20.0 μm, and still more preferably 0.01 to 10.0 μm from the viewpoint that the smoothness is more excellent.

The dispersed phase is preferably flat, and a smooth surface of the smooth dispersed phase is preferably substantially parallel to the resin layer.

In addition, from the viewpoint of reducing the anisotropy of the resin layer, the smooth surface of the smooth dispersed phase is preferably substantially circular in a case of being observed from a direction perpendicular to the surface of the resin layer. It is considered that in a case where such a dispersed phase is dispersed in the resin layer, a dimensional change which occurs in the resin layer can be absorbed, and more excellent surface properties and smoothness can be realized.

The average dispersion diameter and the shape of the dispersed phase can be determined from an observed image obtained by observing a cross-section of the laminate in the thickness direction using a scanning electron microscope (SEM).

The laminate may have a layer other than the metal layer, the adhesion layer, and the resin layer, as necessary. Examples of the other layer include a rust preventive layer and a heat resistant layer.

### Physical Properties of Laminate

### <Roughness of Interface Between Metal Layer and Adhesion Layer>

From the viewpoint that the transmission loss in a high frequency band is more excellent, an average length RSm (hereinafter also referred to as an “RSm of the interface”) of a roughness curve element at an interface between the metal layer and the resin layer in a cross-section of the laminate along the thickness direction is preferably 1.5 μm or less, more preferably 1.2 μm or less, and still more preferably 0.9 μm or less. The lower limit value is not particularly limited, and is, for example, 0.1 μm or more, and preferably 0.3 μm or more.

Furthermore, in a case where the laminate has two metal layers, and two interfaces between the metal layers and the adhesion layer are present, it is preferable that the RSm of at least one interface is in the preferred range, and it is more preferable that the RSm's of both interfaces are in the preferred range.

The RSm of the interface of the laminate can be determined in accordance with JIS B0601:2001. Specifically, a cross-section of the laminate in the thickness direction (lamination direction) is observed using a scanning electron microscope (SEM) (magnification: 50,000 times), and an interface between the metal layer and the resin layer in the obtained observed image is traced over a length of 2,000 nm by an image processing to measure a cross-sectional curve of the interface between the metal layer and the resin layer. Furthermore, a roughness curve is determined from the obtained cross-sectional curve by a roughness curve filter having a cutoff value of 700 nm (high-wavelength side) and a cutoff value of 10 nm (low-wavelength side). The measurement of the roughness curve is performed on the images observed with SEM at 10 points with different cross-sectional positions, and the lengths of the roughness curve elements at a reference length (=a cutoff value on the high-wavelength side) are arithmetically averaged to determine the RSm at the interface.

### <Peel Strength>

The peel strength of the metal layer from the laminate is preferably more than 5.0 N/cm, more preferably 6.0 N/m or more, and still more preferably 6.5 N/cm or more. The more the peel strength, the better the adhesiveness between the resin layer and the metal layer.

The upper limit value of the peel strength of the laminate is not particularly limited, but is, for example, 10.0 N/cm or less.

A method for measuring the peel strength of the laminate will be described in the Example section which will be described later.

### Method for Producing Laminate

A method for producing the laminate is not particularly limited, and examples thereof include a method having a step of manufacturing a polymer film using a composition including a liquid crystal polymer (hereinafter also referred to as a “step 1”), a step of attaching a composition for forming an adhesion layer to the polymer film manufactured in the step 1 to manufacture a resin film (the polymer film with an adhesion layer precursor layer) having the polymer film and the adhesion layer precursor layer) (hereinafter also referred to as a “step 2”), and a step of disposing a metal foil consisting of a metal constituting a metal layer on the adhesion layer precursor layer of the resin film manufactured in the step 2, and then pressure-bonding the resin film and the metal foil under high temperature conditions to manufacture a laminate having the metal layer, the adhesion layer precursor layer, an adhesion layer, and the resin layer in this order (hereinafter also referred to as a “step 3”).

Hereinafter, each of the steps 1 to 3 will be described.

### [Step 1]

The step 1 is a step of manufacturing a polymer film using a composition including a liquid crystal polymer.

The step 1 is not particularly limited, and examples thereof include a method having a pelletizing step of kneading the above-mentioned components constituting the resin layer including a liquid crystal polymer to obtain pellets and a film forming step of forming a polymer film using the pellets.

### <Pelletizing Step>

### (1) Forms of Raw Materials

As the liquid crystal polymer used for film formation, a pellet-shaped, flake-shaped, or powdered polymer can be used as it is, but for the purpose of stabilizing the film formation or uniformly dispersing additives (which means components other than the liquid crystal polymer; the same applies hereinafter), it is preferable to use pellets obtained by kneading one or more kinds of raw materials (meaning at least one of a polymer or an additive; the same applies hereinafter) using an extruder, followed by pelletizing.

### (2) Drying or Drying Alternative by Vent

Before pelletizing, it is preferable to dry the liquid crystal polymer and the additive in advance. Examples of the drying method include a method of circulating heated air having a low dew point, and a method of dehumidifying by vacuum drying. In particular, in a case of a resin that is easily oxidized, vacuum drying or drying using an inert gas is preferable.

### (3) Method for Supplying Raw Materials

A method for supplying raw materials may be any of a method in which raw materials are mixed in advance before kneading and pelletization, and then supplied, a method in which raw materials are separately supplied into an extruder so that the raw materials are at a fixed ratio, and a method from a combination of the both.

### (4) Atmosphere During Extrusion

In a case of melt extrusion, to an extent that uniform dispersion is not hindered, it is preferable to prevent thermal and oxidative deterioration as much as possible, and it is also effective to reduce an oxygen concentration by reducing a pressure using a vacuum pump or inflowing an inert gas. These methods may be carried out alone or in combination.

### (5) Temperature

The kneading temperature is preferably set to be equal to or lower than a thermal decomposition temperature of the liquid crystal polymer and the additive, and is preferably set to a low temperature as much as possible within a range in which a load of the extruder and a decrease in uniform kneading property are not a problem.

### (6) Pressure

A kneading resin pressure while the pelletization is performed is preferably 0.05 to 30 MPa. In a case of a resin in which coloration or gelation is likely to occur due to shearing, it is preferable to apply an internal pressure of approximately 1 to 10 MPa to the inside of the extruder to fill the inside of a twin-screw extruder with the resin raw material.

### (7) Pelletizing Method

As the pelletizing method, a method of solidifying a noodle-shaped extrusion in water and then cutting the extrusion is generally used, but the pelletization may be performed by an under-water cut method for cutting while directly extruding from a mouthpiece into water after melting with the extruder, or a hot cut method for cutting while still hot.

### (8) Pellet Size

A pellet size is preferably 1 to 300 mm² in a cross-sectional area and 1 to 30 mm in a length, and more preferably 2 to 100 mm² in a cross-sectional area and 1.5 to 10 mm in a length.

### (Drying)

### (1) Purpose of Drying

Before forming a molten film, it is preferable to reduce a moisture and a volatile fraction in the pellets, and it is effective to dry the pellets. In a case where the pellets include a moisture or a volatile fraction, not only appearance is deteriorated due to the inclusion of bubbles in the polymer film or the decrease in a haze, but also the physical properties may be deteriorated due to a molecular chain breakage of the liquid crystal polymer, or roll contamination may occur due to generation of monomers or oligomers. In addition, depending on a type of the liquid crystal polymer to be used, it can also make it possible to suppress formation of an oxidative crosslinked substance during molten film formation by removing dissolved oxygen by the drying in some cases.

### (2) Drying Method and Heating Method

In terms of drying efficiency and economy, a dehumidifying hot air dryer is generally used as a drying method, but the drying method is not particularly limited as long as it enables a desired moisture content to be obtained. In addition, there is no problem in selecting a more appropriate method according to the characteristics of physical properties of the liquid crystal polymer.

Examples of the heating method include pressurized steam, heater heating, far-infrared irradiation, microwave heating, and a heat medium circulation heating method.

### <Film Forming Step>

Hereinafter, the film forming step will be described.

### (1) Extrusion Conditions

### Drying of Raw Materials

In a melt plasticization step for pellets using an extruder, it is preferable to reduce a moisture and a volatile fraction in the pellets as in the pelletizing step, and it is effective to dry the pellets.

### Raw Material Supply Method

In a case where there are multiple types of raw materials (pellets) input from the extruder supply port, the raw materials may be mixed in advance (premix method), may be separately supplied into the extruder in a fixed ratio, or may be a combination of the both. In addition, in order to stabilize the extrusion, it is generally practiced to reduce a fluctuation of the temperature and a bulk specific gravity of the raw material charged from the supply port. Moreover, from the viewpoint of a plasticization efficiency, a raw material temperature is preferably high as long as it does not block a supply port by pressure-sensitive adherence, and in a case where the raw material is in an amorphous state, the raw material temperature is preferably in the range of {Glass transition temperature (Tg) (° C.)−150° C.} to {Tg (° C.)−1° C.}, and in a case where the raw material is a crystalline resin, the raw material temperature is preferably in the range of {Melting point (Tm) (C)−150° C.} to {Tm (° C.)−1° C.}, and the raw material is heated or kept warm. In addition, from the viewpoint of the plasticization efficiency, a bulk specific gravity of the raw material is preferably 0.3 times or more, and more preferably 0.4 times or more the bulk specific gravity in a case of a molten state. In a case where the bulk specific density of the raw material is less than 0.3 times the bulk specific gravity in the molten state, it is also preferable to perform a processing treatment such as compressing the raw material into pseudo-pellets.

Atmosphere during Extrusion

As for the atmosphere during melt extrusion, it is necessary to prevent heat and oxidative deterioration as much as possible within a range that does not hinder uniform dispersion as in the pelletizing step. It is also effective to inject an inert gas (nitrogen or the like), reduce the oxygen concentration in the extruder by using a vacuum hopper, and provide a vent port in the extruder to reduce the pressure by a vacuum pump. These depressurization and injection of the inert gas may be carried out independently or in combination.

### Rotation Speed

A rotation speed of the extruder is preferably 5 to 300 rpm, more preferably 10 to 200 rpm, and still more preferably 15 to 100 rpm. In a case where the rotation rate is set to the lower limit value or more, the retention time is shortened, the decrease in the molecular weight can be suppressed due to thermal deterioration, and discoloration can be suppressed. In a case where the rotation rate is set to the upper limit value or less, a breakage of a molecular chain due to shearing can be suppressed, and a decrease in molecular weight and an increase in generation of crosslinked gel can be suppressed. For the rotation speed, it is preferable to select appropriate conditions from the viewpoints of both uniform dispersibility and thermal deterioration due to extension of the retention time.

### Temperature

A barrel temperature (a supply unit temperature of T₁° C., a compression unit temperature of T₂° C., and a measuring unit temperature of T₃° C.) is generally determined by the following method. In a case where the pellets are melt-plasticized at a target temperature T° C. by the extruder, the measuring unit temperature T₃ is set to T±20° C. in consideration of the shear calorific value. At this time, T₂ is set within the range of T₃±20° C. in consideration of the extrusion stability and the thermal decomposability of the resin. Generally, T₁ is set to {T₂ (C)−5° C.} to {T₂(° C.)−150° C.}, and an optimum value thereof is selected from the viewpoint of ensuring a friction between the resin and the barrel, which is a driving force (feed force) for feeding the resin, and preheating at the feed unit. In a case of a normal extruder, it is possible to subdivide each zone of T₁ to T₃ and set the temperature, and by performing settings such that the temperature change between each zone is gentle, it is possible to make it more stable. At this time, T is preferably set to be equal to or lower than the thermal deterioration temperature of the resin, and in a case where it exceeds the thermal deterioration temperature due to the shear heat generation of the extruder, it is generally performed to positively cool and remove the shear heat generation. In addition, in order to achieve both the improved dispersibility and the thermal deterioration, it is also effective to melt and mix a first half part in the extruder at a relatively high temperature and lower the resin temperature in a second half part.

### Pressure

A resin pressure in the extruder is generally 1 to 50 MPa, and from the viewpoints of extrusion stability and melt uniformity, the resin pressure is preferably 2 to 30 MPa, and more preferably 3 to 20 MPa. In a case where the pressure in the extruder is 1 MPa or more, a filling rate of the melting in the extruder is sufficient, and therefore, the destabilization of the extrusion pressure and the generation of foreign matter due to the generation of retention portions can be suppressed. In addition, in a case where the pressure in the extruder is 50 MPa or less, it is possible to suppress the excessive shear stress received in the extruder, and therefore, thermal decomposition due to an increase in the resin temperature can be suppressed.

### Retention Time

A retention time in the extruder (retention time during the film formation) can be calculated from a volume of the extruder portion and a discharge capacity of the polymer, as in the pelletizing step. The retention time is preferably 10 seconds to 60 minutes, more preferably 15 seconds to 45 minutes, and still more preferably 30 seconds to 30 minutes. In a case where the retention time is 10 seconds or longer, the melt plasticization and the dispersion of the additive are sufficient. In a case where the retention time is 30 minutes or less, it is preferable that resin deterioration and discoloration of the resin can be suppressed.

### (Filtration)

### Type, Purpose of Installation, and Structure

It is generally used to provide a filtration equipment at the outlet of the extruder in order to prevent damage to the gear pump due to foreign matter included in the raw material and to extend the life of the filter having a fine pore size installed downstream of the extruder. It is preferable to perform so-called breaker plate type filtration in which a mesh-shaped filtering medium is used in combination with a reinforcing plate having a high opening ratio and having strength.

### Mesh Size and Filtration Area

A mesh size is preferably 40 to 800 mesh, more preferably 60 to 700 mesh, and still more preferably 100 to 600 mesh. In a case where the mesh size is 40 mesh or more, it is possible to sufficiently suppress foreign matter from passing through the mesh. Furthermore, in a case where the mesh is 800 mesh or less, the improvement of the filtration pressure increase speed can be suppressed and the mesh replacement frequency can be reduced. Moreover, in terms of filtration accuracy and strength maintenance, a plurality of types of filter meshes having different mesh sizes are often superimposed and used. In addition, since the filtration opening area can be widened and the strength of the mesh can be maintained, the filter mesh may also be reinforced by using a breaker plate. An opening ratio of the breaker plate used is often 30% to 80% in terms of filtration efficiency and strength.

In addition, a screen changer with the same diameter as the barrel diameter of the extruder is often used, but in order to increase the filtration area, a larger diameter filter mesh is used by using a tapered pipe, or a plurality of breaker plates is also sometimes used by branching a flow channel. The filtration area is preferably selected with a flow rate of 0.05 to 5 g/cm² per second as a guide, more preferably 0.1 to 3 g/cm², and still more preferably 0.2 to 2 g/cm².

By capturing foreign matter, the filter is clogged and the filter pressure rises. At that time, it is necessary to stop the extruder and replace the filter, but a type in which the filter can be replaced while continuing extrusion can also be used. In addition, as a measure against an increase in the filtration pressure due to the capture of foreign matter, a measure having a function of lowering the filtration pressure by cleaning and removing the foreign matter trapped in the filter by reversing the flow channel of the polymer can also be used.

### (Die)

### Type, Structure, and Material

The molten resin, from which the foreign matters have been removed by filtration and in which the temperature has been made uniform by a mixer, is continuously sent to the die. The die is not particularly limited as long as it is designed so that the retention of the molten resin is small, and any type of a T die, a fishtail die, or a hanger coat die, which is commonly used, can also be used. Among these, the hanger coat die is preferable in terms of thickness uniformity and less retention.

### Multilayer Film Formation

A single-layer film forming apparatus having a low equipment cost is used for producing a polymer film. In addition, in order to produce a polymer film having a functional layer such as an adhesion layer, a surface protective layer, a pressure-sensitive adhesion layer, an easy adhesion layer, and/or an antistatic layer, a multilayer film forming apparatus may be used. Specific examples thereof include a method of performing multilayering using a multilayer feed block and a method of using a multi-manifold die. It is preferable to laminate the functional layer thinly on the surface layer, but the layer ratio is not particularly limited.

### (Cast)

The film forming step preferably includes a step of supplying a raw material resin in a molten state from the supply unit and a step of landing the raw material resin in the molten state on a cast roll to form a film. The molten raw material resin may be cooled and solidified, and wound as it is as a polymer film, or it may be passed between a pair of pressurization surfaces and continuously pressurized to form a film.

At this time, the unit for supplying the raw material resin (melt) in a molten state is not particularly limited. For example, as a specific unit for supplying the melt, an extruder which melts the raw material resin including the liquid crystal polymer and extrudes it into a film may be used, an extruder and a die may be used, or the raw material resin may be once solidified into a film and then molten by a heating unit to form a melt, which may be supplied to the film forming step.

In a case where the molten resin extruded from the die into a sheet is pressed by a device having a pair of pressurization surfaces, not only can the surface morphology of the pressurization surface be transferred to a surface of the polymer film, but aligning properties can be controlled by imparting elongation deformation to the composition including the liquid crystal polymer.

### Film Forming Method and Type

Among the methods for molding a raw material resin in a molten state into a film, it is preferable to pass between two rolls (for example, a touch roll and a chill roll) from the viewpoint that a high pressurizing force can be applied and the surface shape of the polymer film is excellent. Furthermore, in the present specification, in a case where a plurality of cast rolls for transporting a molten substance are provided, the cast roll closest to a supply unit (for example, a die) for the most upstream liquid crystal polymer is referred to as a chill roll. Additionally, a method of pressurizing metal belts with each other or a method of combining a roll and a metal belt can also be used. In addition, in some cases, in order to improve the adhesiveness with the roll or the metal belt, a film forming method such as a static electricity application method, an air knife method, an air chamber method, and a vacuum nozzle method can be used in combination, on a cast drum.

Moreover, in a case of obtaining a polymer film having a multilayer structure, it is preferable to obtain a polymer film by pressurizing a raw material resin including a molten polymer extruded from a die in multiple layers, but it is also possible to obtain a polymer film having a multilayer structure by introducing a polymer film having a single-layer structure into a pressing portion in the same manner as for molten laminating. In addition, at this time, polymer films having different inclined structures in the thickness direction can be obtained by changing a circumferential speed difference or an alignment axis direction of the pressurization portion, and polymer films having three or more layers can be obtained by performing this step several times.

Furthermore, the touch roll may be periodically vibrated in the TD direction in a case of pressurizing to give deformation.
Temperature of Molten Polymer

In terms of the improvement of the moldability of the liquid crystal polymer and the suppression of deterioration, a discharge temperature (resin temperature at an outlet of the supply unit) is preferably (Tm of liquid crystal polymer −10)° C. to (Tm of liquid crystal polymer +40)° C. As a guide for the melt viscosity, 50 to 3,500 Pa·s is preferable.

It is preferable that the cooling of the molten polymer between the air voids is as small as possible, and it is preferable to reduce a temperature drop due to the cooling by taking measures such as increasing the film forming speed and shortening the air void.

### Temperature of Touch Roll

A temperature of the touch roll is preferably set to Tg or less of the liquid crystal polymer. In a case where the temperature of the touch roll is Tg or less of the liquid crystal polymer, pressure-sensitive adhesion of the molten polymer to the roll can be suppressed, and therefore, the polymer film appearance is improved. For the same reason, the chill roll temperature is preferably set to Tg or less of the liquid crystal polymer.

### Film Formation Procedure

In the film forming step, in terms of the film forming step and the stabilization of quality, it is preferable to perform the film formation by the following procedure.

The molten polymer discharged from the die is landed on a cast roll to form a film, which is then cooled and solidified, and thus wound up as a polymer film.

In a case of performing the pressurization of the molten polymer, the molten polymer is passed between the first pressurization surface and the second pressurization surface set at a predetermined temperature, and then is cooled and solidified and wound up as a polymer film.

### <Stretching Step, Thermal Relaxation Treatment, and Thermal Fixation Treatment>

Furthermore, after forming an unstretched polymer film by the method, the unstretched polymer film may be continuously or discontinuously stretched and/or subjected to a thermal relaxation treatment or a thermal fixation treatment. For example, each step can be carried out by the combination of the following (a) to (g). In addition, the order of the machine-direction stretching and the cross-direction stretching may be reversed, each step of the machine-direction stretching and the cross-direction stretching may be performed in multiple stages, and each step of the machine-direction stretching and the cross-direction stretching may be combined with diagonal stretching or simultaneous biaxial stretching.
(a) Cross-direction stretching
(b) Cross-direction stretching→Thermal relaxation treatment
(c) Machine-direction stretching
(d) Machine-direction stretching→Thermal relaxation treatment
(e) Machine-direction (cross-direction) stretching→Cross-direction (machine-direction) stretching
(f) Machine-direction (cross-direction) stretching→Cross-direction (machine-direction) stretching→Thermal relaxation treatment
(g) Cross-direction stretching→Thermal relaxation treatment→Machine-direction stretching→Thermal relaxation treatment

Hereinafter, the unstretched polymer film and the stretched polymer film are collectively referred to simply as a “film”.

### Machine-Direction Stretching

The machine-direction stretching can be achieved by making the circumferential speed on the outlet side faster than the circumferential speed on the inlet side while heating between the two pairs of rolls. From the viewpoint of suppressing a curl, it is preferable that the film temperatures are the same on the front and back surfaces of the film to be subjected to a stretching treatment, but in a case where optical characteristics are controlled in the thickness direction, the stretching can be performed at different temperatures on the front and back surfaces. Furthermore, the stretching temperature herein is defined as a temperature on the lower side of the film surface. The machine-direction stretching step may be carried out in either one step or multiple steps. The unstretched film is often preheated by passing it through a temperature-controlled heating roll, but in some cases, a heater can be used to heat the unstretched film. In addition, a ceramic roll or the like having improved adhesiveness can also be used in order to prevent the film from being subjected to a stretching treatment from pressure-sensitive adherence to the roll.

### Cross-Direction Stretching

As the cross-direction stretching step, normal cross-direction stretching can be adopted. That is, examples of the normal cross-direction stretching include a stretching method in which both ends in the width direction of the film to be subjected to a stretching treatment are gripped with clips, and the clips are widened while being heated in an oven using a tenter. With regard to the cross-direction stretching step, for example, methods described in JP1987-035817U (JP-S62-035817U), JP2001-138394A, JP1998-249934A (JP-H10-249934A), JP1994-270246A (JP-H06-270246A), JP1992-030922U (JP-H04-030922U), and JP1987-152721A (JP-S62-152721A) can be used, and these methods are herein incorporated by reference.

A stretching ratio (cross-direction stretching ratio) in the width direction of the film in the cross-direction stretching step is preferably 1.2 to 6 times, more preferably 1.5 to 5 times, and still more preferably 2 to 4 times. In addition, the cross-direction stretching ratio is preferably larger than the stretching ratio of the machine-direction stretching in a case where the machine-direction stretching is performed.

A stretching temperature in the cross-direction stretching step can be controlled by blowing air at a desired temperature into a tenter. The film temperatures may be the same or different on the front and back surfaces for the same reason as in the machine-direction stretching. The stretching temperature used herein is defined as a temperature on the lower side of the film surface. The cross-direction stretching step may be carried out in one step or in multiple steps. In addition, in a case of performing cross-direction stretching in multiple stages, the cross-direction stretching may be performed continuously or intermittently by providing a zone in which widening is not performed. For such the cross-direction stretching, in addition to the normal cross-direction stretching in which a clip is widened in the width direction in a tenter, a stretching method as below, in which a clip is widened by gripping, can also be applied.

### Diagonal Stretching

In the diagonal stretching step, the clips are widened in the cross-direction in the same manner as in the normal cross-direction stretching, but can be stretched diagonally by changing a transportation speed of the left and right clips. As the diagonal stretching step, for example, the methods described in JP2002-022944A, JP2002-086554A, JP2004-325561A, JP2008-023775A, and JP2008-110573A can be used.

### Simultaneous Biaxial Stretching

The simultaneous biaxial stretching is a treatment in which clips are widened in the cross-direction, and simultaneously stretched or contracted in the machine direction, in a similar manner to the normal cross-direction stretching. As the simultaneous biaxial stretching, for example, the methods described in JP1980-093520U (JP-S55-093520U), JP1988-247021A (JP-S63-247021A), JP1994-210726A (JP-H06-210726A), JP1994-278204A (JP-H06-278204A), JP2000-334832A, JP2004-106434A, JP2004-195712A, JP2006-142595A, JP2007-210306A, JP2005-022087A, JP2006-517608A, and JP2007-210306A can be used.
Heat Treatment to Improve Bowing (Axis Misalignment)

Since the end part of the film is gripped by the clip in the cross-direction stretching step, the deformation of the film due to a thermal shrinkage stress generated during a heat treatment is large at the center of the film and is small at the end parts, and as a result, the characteristics in the width direction can be distributed. In a case where a straight line is drawn along the cross-direction on a surface of the film before the heat treatment step, the straight line on the surface of the film after the heat treatment step is an arcuate shape in which the center portion is recessed toward the downstream side. This phenomenon is called a bowing phenomenon, and causes the isotropy and the widthwise uniformity of the film to be disturbed.

With an improvement method therefor, it is possible to reduce a variation in an alignment angle due to the bowing by performing preheating before the cross-direction stretching or by performing the thermal fixation after the stretching. Any one of the preheating or the thermal fixation may be performed, but it is more preferable to perform the both. It is preferable to perform the preheating and the thermal fixation by gripping with a clip, that is, it is preferable to perform the preheating and the thermal fixation continuously with the stretching.

The preheating temperature is preferably higher than the stretching temperature by approximately 1° C. to 50° C., more preferably 2° C. to 40° C., and still more preferably 3° C. to 30° C. The preheating time is preferably 1 second to 10 minutes, more preferably 5 seconds to 4 minutes, and still more preferably 10 seconds to 2 minutes.

During the preheating, it is preferable to keep the width of the tenter almost constant. The term “almost” as mentioned herein refers to ±10% of the width of the unstretched film.

The thermal fixation temperature is lower than the stretching temperature by preferably 1° C. to 50° C., more preferably 2° C. to 40° C., and still more preferably 3° C. to 30° C. The thermal fixation temperature is preferably a temperature that is no higher than stretching temperature and no higher than the Tg of the liquid crystal polymer.

The thermal fixation time is preferably 1 second to 10 minutes, more preferably 5 seconds to 4 minutes, and still more preferably 10 seconds to 2 minutes. In a case of the thermal fixation, it is preferable to keep the width of the tenter almost constant. The term “almost” as mentioned herein means 0% (the same width as the tenter width after stretching) to −30% (30% smaller than the tenter width after stretching=reduced width) of the tenter width after the completion of stretching. Examples of other known methods include the methods described in JP1989-165423A (JP-H01-165423A), JP1991-216326A (JP-H03-216326A), JP2002-018948A, and JP2002-137286A.
Thermal Relaxation Treatment

After the stretching step, a thermal relaxation treatment in which the film is heated to shrink the film may be performed. By performing the thermal relaxation treatment, the thermal shrinkage rate of the polymer film during the use of the laminate can be reduced. It is preferable that the thermal relaxation treatment is carried out at at least one timing of a time after film formation, a time after machine-direction stretching, or a time after cross-direction stretching.

The thermal relaxation treatment may be continuously performed online after the stretching, or may be performed offline after winding after the stretching. Examples of the temperature of the thermal relaxation treatment include a temperature of a glass transition temperature Tg or higher and a melting point Tm or lower of the liquid crystal polymer. In a case where there is a concern about oxidative deterioration of the polymer film, the thermal relaxation treatment may be performed in an inert gas such as a nitrogen gas, an argon gas, and a helium gas.

### <Preheating Treatment>

In the step 1, it is preferable to perform a preheating treatment in which the film is heated while fixing the film width after carrying out cross-direction stretching of the film from the viewpoint that the thermal dimensional stability is more excellent, more specifically, the shrinkage of the film during the heating in a later step can be suppressed.

In the preheating treatment, a heat treatment is performed while fixing the film width by a fixing method such as gripping both ends of a film in the width direction with clips. The film width after the preheating treatment is preferably 85% to 105%, and more preferably 95% to 102% with respect to the film width before the preheating treatment.

The heating temperature in the preheating treatment is preferably {Tm−200}° C. or higher, more preferably {Tm−100}° C. or higher, and still more preferably {Tm−50}° C. or higher, with the melting point of the liquid crystal polymer being taken as Tm (° C.). The upper limit of the heating temperature in the preheating treatment is preferably {Tm}° C. or lower, more preferably {Tm−2}° C. or lower, and still more preferably {Tm−5}° C. or lower.

Alternatively, the heating temperature in the preheating treatment is preferably 240° C. or higher, more preferably 255° C. or higher, and still more preferably 270° C. or higher. The upper limit is preferably 315° C. or lower, and more preferably 310° C. or lower.

Examples of the heating unit used for the preheating treatment include a hot air dryer and an infrared heater, and the infrared heater is preferable since a film having a desired melting peak surface area can be manufactured in a short time. In addition, as the heating unit, pressurized steam, microwave heating, and a heat medium circulation heating method may be used.

A treatment time for the preheating treatment can be appropriately adjusted according to the type of the liquid crystal polymer, the heating unit, and the heating temperature, and in a case where the infrared heater is used, the treatment time is preferably 1 to 120 seconds, and more preferably 3 to 90 seconds. In addition, in a case where the hot air dryer is used, the treatment time is preferably 0.5 to 30 minutes, and more preferably 1 to 10 minutes.

### <Surface Treatment>

Since the adhesiveness between the polymer film and a metal layer such as a copper foil and a copper plating layer, or another layer can be further improved, it is preferable to subject the polymer film to a surface treatment. Examples of the surface treatment include a glow discharge treatment, an ultraviolet irradiation treatment, a corona treatment, a flame treatment, and an acid or alkali treatment. The glow discharge treatment as mentioned herein may be a treatment with a low-temperature plasma generated in a gas at a low pressure ranging from 10⁻³ to 20 Torr, and is preferably a plasma treatment under atmospheric pressure.

The glow discharge treatment is performed using a plasma-excited gas. The plasma-excited gas refers to a gas that is plasma-excited under the above-described conditions, and examples thereof include fluorocarbons such as argon, helium, neon, krypton, xenon, nitrogen, carbon dioxide, and tetrafluoromethane, and mixtures of these.

It is also useful to subject the polymer film to an aging treatment at a temperature which is no higher than the Tg of the liquid crystal polymer in order to improve the mechanical properties, thermal dimensional stability, or winding shape of the wound polymer film.

In addition, with regard to the polymer film, the smoothness of the polymer film may be further improved by further performing a step of pressing the polymer film with a heating roll and/or a step of stretching the polymer film after performing the film forming step.

In the manufacturing method, the case where the polymer film is a single layer is described, but the polymer film may have a laminated structure in which a plurality of layers are laminated.

### [Step 2]

The step 2 is a step of adhering a composition for forming an adhesion layer onto the polymer film manufactured in the step 1 to manufacture a resin film having the polymer film and the adhesion layer precursor layer (the polymer film with adhesion layer precursor layer).

Examples of the step 2 include a step of applying a composition for forming an adhesion layer onto at least one surface of the polymer film manufactured in the step 1 to form a coating film (the adhesion layer precursor layer). In addition, the adhesion layer precursor layer consisting of the coating film may be dried and/or cured, as necessary.

Examples of the composition for forming an adhesion layer include a composition including the components constituting the adhesion layer, such as the binder resin, the reactive compound, and the additive, and a solvent. Since the components constituting the adhesion layer are as described above, descriptions thereof will be omitted.

Examples of the solvent (organic solvent) include ester compounds (for example, ethyl acetate, n-butyl acetate, and isobutyl acetate) and ether compounds (for example, ethylene glycol dimethyl ether, diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, and diethylene glycol monoethyl ether), ketone compounds (for example, methyl ethyl ketone, cyclohexanone, cyclopentanone, 2-heptanone, and 3-heptanone), hydrocarbon compounds (hexane, cyclohexane, and methylcyclohexane), as well as aromatic hydrocarbon compounds (for example, toluene and xylene).

The solvents may be used alone or in two or more kinds thereof.

A content of the solvent is preferably 0.0005% to 0.02% by mass, and more preferably 0.001% to 0.01% by mass with respect to the total mass of the composition for forming an adhesion layer.

A solid content of the composition for forming an adhesion layer is preferably 99.98% to 99.9995% by mass, and more preferably 99.99% to 99.999% by mass with respect to the total mass of the composition for forming an adhesion layer.

In the present specification, the “solid content” of a composition means components excluding a solvent and water. That is, the solid content of the composition for forming an adhesion layer is intended to be components constituting the adhesion layer, such as the binder resin, the reactive compound, and the additive.

A method for adhering the composition for forming an adhesion layer on the polymer film is not particularly limited, and examples thereof include a bar coating method, a spray coating method, a squeegee coating method, a flow coating method, a spin coating method, a dip coating method, a die coating method, an ink jet method, and a curtain coating method.

In a case where the coating film of the composition for forming an adhesion layer adhered on the polymer film is dried, the drying conditions are not particularly limited, but the drying temperature is preferably 25° C. to 200° C. and the drying time is preferably 1 second to 120 minutes.

### [Step 3]

In the step 3, a metal foil consisting of a metal that constitutes a metal layer is disposed on the adhesion layer precursor layer of the resin film manufactured in the step 2, and then the resin film and the metal foil are pressure-bonded (thermocompressed) under high temperature conditions, whereby a laminate having the metal layer, the adhesion layer precursor layer, the adhesion layer, and the resin layer in this order can be obtained.

The methods and the conditions for the thermocompression of the resin film and the metal foil in the step 3 are not particularly limited, and are appropriately selected from known methods and conditions.

The temperature condition for the thermocompression is preferably 100° C. to 300° C., the pressure condition for thermocompression is preferably 0.1 to 20 MPa, and the treatment time for the thermocompression is preferably 0.001 to 1.5 hours.

From the viewpoint of manufacturing a laminate in which voids between the metal layer and the adhesion layer are reduced, it is preferable to subject the resin film to a preliminary heating and drying treatment before laminating the metal foil on the resin film manufactured in the step 2. It is considered that the voids between the metal layer and the adhesion layer in the laminate manufactured in the step 3 can be reduced by performing the preliminary heating and drying treatment to vaporize water (for example, moisture absorbed by the resin film between the step 2 and the step 3) and an organic solvent included as impurities in the adhesion layer precursor layer.

The temperature condition for the preliminary heating and drying treatment is preferably 60° C. to 140° C., and more preferably 80° C. to 130° C. In addition, in a case where the boiling point of the solvent included in the composition for forming an adhesion layer is defined as T (° C.), the temperature condition for the preliminary heating and drying treatment is preferably in the range of T to (T+40)° C., and more preferably in the range of T to (T+30)° C. In addition, the heating time of the preliminary heating and drying treatment is preferably 1 second to 720 minutes.

Examples of the heating method include heater heating, far-infrared irradiation, microwave heating, and heat medium circulation heating methods.

Moreover, the method for producing a laminate of the embodiment of the present invention is not limited to the method having the steps 1, 2, and 3.

For example, the composition for forming an adhesion layer used in the step 2 is applied onto at least one surface of the metal foil, the coating film is dried and/or cured to form an adhesion layer precursor layer, then the metal foil with the adhesion layer precursor layer and the polymer film manufactured according to the method described in the step 1 are laminated so that the adhesion layer precursor layer is in contact with the polymer film, and subsequently, the metal foil, the adhesion layer precursor layer, and the polymer film are subjected to thermocompression according to the method described in the step 3, whereby a laminate having the metal layer, the adhesion layer, and the resin layer can be produced.

### [Use of Laminate]

Examples of the use of the laminate include a laminated circuit board, a flexible laminated board, and a wiring board such as a flexible printed wiring board (FPC). The laminate is particularly preferably used as a high-speed communication substrate.

### EXAMPLES

Hereinbelow, the present invention will be more specifically described with reference to Examples. The materials, the amounts of materials used, the proportions, the treatment details, and the treatment procedure shown in Examples below may be modified as appropriate as long as the modifications do not depart from the spirit of the present invention. Therefore, the present invention is not limited to the aspects shown in Examples below. Furthermore, the terms “part” and “%” are based on mass unless otherwise specified.

### Raw Materials

### <Resin Composition for Forming Resin Layer>

### (Liquid Crystal Polymer)

LCP1: A polymer synthesized based on Example 1 of JP2019-116586A (melting point Tm: 320° C., standard dielectric loss tangent: 0.0012).

LCP1 is composed of a repeating unit derived from 6-hydroxy-2-naphthoic acid, a repeating unit derived from 4,4′-dihydroxybiphenyl, a repeating unit derived from terephthalic acid, and a repeating unit derived from 2,6-naphthalenedicarboxylic acid.

Furthermore, the standard dielectric loss tangent of LCP1 was measured by a cavity resonator perturbation method using a cavity resonator (CP-531 manufactured by Kanto Electronics Application & Development, Inc.) according to the above-mentioned method.

### (Polyolefin Component)

PE1: “Novatec (registered trademark) LD” (low density polyethylene) manufactured by Japan Polyethylene Corporation

### (Compatible Components)

Compatible component 1: “Bond First (registered trademark) E” manufactured by Sumitomo Chemical Co., Ltd. (copolymer of ethylene and glycidyl methacrylate (E-GMA copolymer))

### <Metal Foil>

As the metal foil, a non-roughened copper foil with a thickness of 18 μm and an RSm of 0.5 μm of a surface on the non-roughened surface (copper foil 1) was used.

### Example 1

A laminate having a metal layer, an adhesion layer, and a resin layer in this order was produced by the following method.

### Manufacture of Polymer Film (Step 1)

### <Supply Step>

A resin composition consisting of only a liquid crystal polymer LCP1 was pelletized using an extruder. The pelletized resin composition was dried for 12 hours using a dehumidifying hot air dryer having a heating temperature of 80° C. and a dew point temperature of −45° C. As a result, a moisture content of the pellets of the resin composition was set to 200 ppm or less. The pellets dried in this manner are also referred to as a raw material A.

### <Film Forming Step>

The raw material A in a molten state was supplied into a cylinder from the same supply port of a biaxial extruder having a screw diameter of 50 mm, heat-kneaded, discharged from a die having a die width of 750 mm onto a rotating cast roll in a form of a film, cooled, solidified, and stretched as desired to obtain a polymer film with a thickness of 150 μm.

Furthermore, the temperature of heating and kneading, the discharge rate in a case of discharging the raw material A, the clearance of the die lip, and the circumferential speed of the cast roll were each adjusted in the following ranges.
Temperature of heating and kneading: 270° C. to 350° C.
Dye lip clearance: 0.01 to 5 mm
Discharge rate: 0.1 to 1,000 mm/sec
Circumferential speed of cast roll: 0.1 to 100 m/min

### <Cross-Direction Stretching Step>

The polymer film manufactured in the film forming step was stretched in the TD direction using a tenter. A stretching ratio at this time was 3.2 times.

### <Preheating Treatment>

The obtained polymer film was subjected to the following heat treatment using a hot air dryer.

Both ends of the polymer film in the width direction were gripped with a jig, and the polymer film was fixed so as not to shrink in the width direction. The polymer film fixed with the jig was placed in a hot air dryer and heated for 10 seconds under the condition of a film surface temperature of 300° C., and then the polymer film was taken out from the hot air dryer.

In the preheating treatment, a film for measuring the film surface temperature was placed in the vicinity of the polymer film to be heat-treated, and the film surface temperature of the polymer film was measured using a thermocouple attached to the surface of the film for measuring the film surface temperature with a tape made of a polyimide material.

### Formation of Adhesion Layer (Adhesion Layer Precursor Layer) (Step 2)

Both surfaces of the polymer film that had been preheated were subjected to a corona treatment using a corona treatment device.

Next, 17.7 g of a polyimide resin solution (“PIAD-200” manufactured by Arakawa Chemical Industries, Ltd., solid content of 30% by mass, solvents: cyclohexanone, methylcyclohexane, and ethylene glycol dimethyl ether), 0.27 g of 4-t-butylphenyl glycidyl ether (manufactured by Tokyo Kasei Kogyo Co., Ltd.), and 1.97 g of toluene were mixed and stirred to prepare a composition for forming an adhesion layer (coating liquid 1) having a concentration of solid contents of 28% by mass.

The obtained coating liquid 1 was applied onto one surface of the surface-treated polymer film using a bar coater to form a coating film. The coating film was dried using a dry oven under the conditions of 130° C. and 20 minutes to provide an adhesion layer precursor layer with a thickness of 1 μm. Furthermore, the coating liquid 1 was also used in the same manner as above on the surface on the polymer film on a side opposite to the side where the adhesion layer precursor layer had been provided, thereby forming a coating film, and the coating film was dried to provide the adhesion layer precursor layer with a thickness of 1 μm. As a result, a resin film 1 having the resin layer and the adhesion layer precursor layer formed on both surfaces of the resin layer was manufactured.

### Production of Laminate (Step 3)

The resin film 1 manufactured in the step was heated and dried at a temperature of 100° C. for 60 minutes using a dry oven. Subsequently, the heated and dried resin film 1 and the two copper foils 1 were laminated such that the adhesion layer precursor layer of the resin film 1 and the non-roughened surface of the copper foil 1 were in contact with each other. Next, a laminate 1 in which the metal layer, the adhesion layer obtained by curing the adhesion layer precursor layer, the resin layer, the adhesion layer obtained by curing the adhesion layer precursor layer, and the metal layer were laminated in this order was manufactured by performing pressure bonding for 1 hour under conditions of 200° C. and 2.5 MPa using a hot press machine (manufactured by Toyo Seiki Seisaku-sho, Ltd.). The thickness of any of the adhesion layers was 1 μm.

### Evaluation of Laminate

The laminate manufactured in Example 1 was evaluated as follows.

### Measurement of Void

A void at an interface between the metal layer and the adhesion layer of the laminate of Example 1 was measured by the method shown below, using an ultrasonic inspection device (FineSAT (registered trademark) III manufactured by Hitachi Power Solutions Co., Ltd.).

The produced laminate was cut into a size of 300 mm×300 mm to manufacture a total of 10 samples. The obtained sample was irradiated with ultrasonic waves having a frequency of 300 MHz from a normal direction with respect to the main surface of the sample, and the reflected ultrasonic waves were scanned. The interface between the metal layer and the adhesion layer was imaged based on a waveform detected by the scanning, and the number of voids (defects) was counted from the obtained image. Furthermore, in consideration of a detection limit of the inspection device, the voids with a major axis of 1 μm or more were measured. For the 10 manufactured samples, the number of voids at the interface between the metal layer and the adhesion layer was measured by the method, and from the total number of measured voids, the number of voids with a major axis of 10 μm or less per square meter and the number of voids with a major axis of more than 10 μm per square meter were calculated for the laminate manufactured in Example 1.

As a result, the number of voids with a major axis of 10 μm or less was 85 voids/m². In addition, no void with a major axis of more than 10 μm was observed in any of the samples, and the number of voids with a major axis of more than 10 μm was 0 voids/m².

### <Measurement of RSm>

The RSm at an interface between the metal layer and the adhesion layer of the laminate manufactured in Example 1 was measured by the above-mentioned method using SEM.

The measurement results are shown in Table 1 which will be described later.

### <Measurement of Peel Strength>

The laminate of Example 1 was cut into a strip shape of 10 mm×50 mm to manufacture a sample for evaluating a peel strength. A peel strength (unit: N/cm) of the obtained sample was measured according to the method for measuring a peel strength of a flexible printed wiring board described in JIS C 5016-1994. An adhesiveness measurement test was carried out by peeling off the copper foil at a peeling speed of 50 mm/min in a direction at an angle of 90° with respect to a copper foil removal surface, using a tensile tester (manufactured by IMADA Co., Ltd., Digital Force Gauge ZP-200N).

As a result of the measurement, the peel strength of the laminate of Example 1 was 7.0 N/cm.

With regard to the measurement results of the peel strength, the peel strength of the laminate was evaluated according to the following evaluation standard.

### Evaluation Standard for Peel Strength

A: The peel strength was 6.0 N/cm or more.
B: The peel strength was less than 6.0 N/cm.

### Comparative Example 1

A laminate was manufactured according to the method described in Example 1, except that in the step 2, the coating film formed of the coating liquid 1 was dried under the conditions of 85° C. and 10 minutes to provide an adhesion layer with a thickness of 1 μm.

As a result of evaluating the characteristics of the obtained laminate, the number of voids with a major axis of 10 μm or less was 200 voids/m². In addition, no void with a major axis of more than 10 μm was observed in any of the samples, and the number of voids with a major axis of more than 10 μm was 0 voids/m².

For the laminate of Comparative Example 1, the RSm at the interface between the metal layer and the adhesion layer and the peel strength of the laminate were measured according to the procedure described in Example 1. The measurement results are shown in Table 1 which will be described later.

### Comparative Example 2

A laminate was manufactured according to the method described in Example 1, except that in the step 2, the coating amount of the coating liquid 1 was adjusted such that the thickness of the adhesion layer obtained by drying was 8 μm.

As a result of evaluating the characteristics of the obtained laminate, the number of voids with a major axis of 10 μm or less was 150 voids/m². In addition, no void with a major axis of more than 10 μm was observed in any of the samples, and the number of voids with a major axis of more than 10 μm was 0 voids/m².

For the laminate of Comparative Example 2, the RSm at the interface between the metal layer and the adhesion layer and the peel strength of the laminate were measured according to the procedure described in Example 1. The measurement results are shown in Table 1 which will be described later.

### Results

The characteristics of the laminate manufactured in each of Examples and the evaluation results of each laminate are shown in Table 1 below.

TABLE 1

| | | | Peel strength | |
|---|---|---|---|---|
| | Number | RSm of | Measured | |
| | of voids | interface | value | |
| | [voids/m²] | [μm] | [N/cm] | Evaluation |
| Example 1 | 85 | 0.5 | 7.0 | A |
| Comparative | 200 | 0.5 | 5.3 | B |
| Example 1 | | | | |
| Comparative | 150 | 0.5 | 5.5 | B |
| Example 2 | | | | |

From the results shown in Table 1, it was confirmed that the object of the present invention can be accomplished with the laminate of the embodiment of the present invention.

What is claimed is:

1. A laminate comprising, in this order:
a metal layer;
an adhesion layer; and
a resin layer,
wherein the resin layer includes a liquid crystal polymer, and
there is no void between the metal layer and the adhesion layer, or in a case where there is such a void, there is no void with a major axis of more than 10 μm and the number of voids with a major axis of 10 μm or less is 100 voids/m² or less.

2. The laminate according to claim 1,
wherein the liquid crystal polymer includes two or more kinds of repeating units derived from a dicarboxylic acid.

3. The laminate according to claim 1,
wherein the liquid crystal polymer has at least one selected from the group consisting of a repeating unit derived from 6-hydroxy-2-naphthoic acid, a repeating unit derived from an aromatic diol, a repeating unit derived from terephthalic acid, and a repeating unit derived from 2,6-naphthalenedicarboxylic acid.

4. The laminate according to claim 1,
wherein an average length RSm of roughness curve elements of an interface between the metal layer and the adhesion layer in a cross-section along a thickness direction is 1.2 μm or less.

5. The laminate according to claim 1,
wherein a thickness of the adhesion layer is 0.3 to 5.0 μm.

6. The laminate according to claim 1,
wherein the metal layer is a copper layer.

7. The laminate according to claim 1,
wherein a peel strength of the metal layer from the laminate is 6.0 N/cm or more.

8. The laminate according to claim 2,
wherein the liquid crystal polymer has at least one selected from the group consisting of a repeating unit derived from 6-hydroxy-2-naphthoic acid, a repeating unit derived from an aromatic diol, a repeating unit derived from terephthalic acid, and a repeating unit derived from 2,6-naphthalenedicarboxylic acid.

9. The laminate according to claim 2,
wherein an average length RSm of roughness curve elements of an interface between the metal layer and the adhesion layer in a cross-section along a thickness direction is 1.2 μm or less.

10. The laminate according to claim 2,
wherein a thickness of the adhesion layer is 0.3 to 5.0 μm.

11. The laminate according to claim 2,
wherein the metal layer is a copper layer.

12. The laminate according to claim 2,
wherein a peel strength of the metal layer from the laminate is 6.0 N/cm or more.

13. The laminate according to claim 3,
wherein an average length RSm of roughness curve elements of an interface between the metal layer and the adhesion layer in a cross-section along a thickness direction is 1.2 μm or less.

14. The laminate according to claim 3,
wherein a thickness of the adhesion layer is 0.3 to 5.0 μm.

15. The laminate according to claim 3,
wherein the metal layer is a copper layer.

16. The laminate according to claim 3,
wherein a peel strength of the metal layer from the laminate is 6.0 N/cm or more.

17. The laminate according to claim 4,
wherein a thickness of the adhesion layer is 0.3 to 5.0 μm.

18. The laminate according to claim 4,
wherein the metal layer is a copper layer.

19. The laminate according to claim 4,
wherein a peel strength of the metal layer from the laminate is 6.0 N/cm or more.

20. The laminate according to claim 5,
wherein the metal layer is a copper layer.
